(19) United States
(12) Patent Application Publication
(10) Pub. No.: US 2024/0373460 A1
(43) Pub. Date: Nov. 7, 2024

(54) SIDELINK TRANSMISSION METHOD AND APPARATUS

(71) Applicant: FUJITSU LIMITED, Kawasaki-shi Kanagawa (JP)

(72) Inventors: Jian ZHANG, Beijing (CN); Qinyan JIANG, Beijing (CN); Guorong LI, Beijing (CN); Xin WANG, Beijing (CN)

(73) Assignee: FUJITSU LIMITED, Kawasaki-shi Kanagawa (JP)

(21) Appl. No.: 18/770,855

(22) Filed: Jul. 12, 2024

Related U.S. Application Data
(63) Continuation of application No. PCT/CN2022/074645, filed on Jan. 28, 2022.

(51) Int. Cl. H04W 74/0808; H04W 74/00; H04W 92/18

(52) U.S. Cl. CPC H04W 74/0808; H04W 74/002; H04W 92/18

(57) ABSTRACT

A sidelink transmission apparatus includes: processor circuitry configured to determine a candidate resource set on an unlicensed frequency band; select a transmission resource in the candidate resource set; determine a listen before talk (LBT) class for a sidelink transmission; and determine a second channel occupancy time to share according to one or more first channel occupancy times; a transmitter configured to transmit sidelink information on the transmission resource when listen before talk which is performed according to the listen before talk class is successful; and a receiver configured to receive one or more COT indications indicating the one or more first channel occupancy times

### CROSS-REFERENCE TO RELATED APPLICATION

This application is a continuation application of International Application PCT/CN2022/074645 filed on Jan. 28, 2022, and designated the U.S., the entire contents of which are incorporated herein by reference.

### TECHNICAL FIELD

Embodiments of the present application relate to the field of communications technologies.

### BACKGROUND

3GPP completed the standardization of the new radio (NR) sidelink in Rel-16, and the main application scenario thereof is for V2X (Vehicle to Everything), also referred to as NR V2X. In contrast to cellular communication using a Uu link, a transmitting device communicates directly with a receiving device via a sidelink.

NR sidelink Performs sidelink communication in resource pools. The defined physical channels include a physical sidelink control channel (PSCCH), a physical sidelink shared channel (PSSCH) and a physical sidelink feedback channel (PSFCH). The PSCCH carries 1st stage sidelink control information (SCI). The 1st stage SCI is mainly used to reserve resources. The PSSCH carries 2nd stage SCI and data, in which the 2nd stage SCI is mainly used for data demodulation. The PSFCH carries sidelink feedback information (HARQ-ACK).

The NR sidelink defines two resource allocation modes. For mode 1, the resources used by a terminal equipment for sidelink communication are scheduled or configured by a network device (a base station) over the NR Uu link. For mode 2, a terminal equipment may autonomously select time-frequency resources for sidelink communication based on its own perception results.

In order to meet the growing demand for sidelink communication, especially the demand from commercial scenarios, sidelink evolves into one of projects for 3GPP in Rel-18 (also referred to as 5G-Advanced). One of the research contents of the Rel-18 sidelink project is sidelink-based unlicensed access (SL-U), the main driver of which is to support higher data rates through the use of unlicensed spectrum (or shared spectrum).

It should be noted that, the above introduction to the background is merely for the convenience of clear and complete description of the technical solution of the present application, and for the convenience of understanding of persons skilled in the art. It cannot be regarded that the above technical solution is commonly known to persons skilled in the art just because that the solution has been set forth in the background of the present application.

### SUMMARY

The inventor found that SL-U is mainly used in commercial scenarios, but not excluding V2X applications with a high degree of automation. Taking commercial scenarios as an example, a high data rate is an indispensable and important indicator of XR technologies such as virtual reality (VR), augmented reality (AR), and SL-U may meet the high rate requirements by using additional spectrum. In addition, industry Internet of Things (IoT) and smart home are also scenarios suitable for the deployment and use of SL-U.

SL-U has just been established in Rel-18, and the specific standardization work has not yet started in 3GPP. At present, how to carry out sidelink transmission based on resource allocation mode 2 (autonomous resource selection) in SL-U is still an open problem.

To address at least one of the above problems, embodiments of the present application provide a sidelink transmission method and apparatus.

According to one aspect of the embodiments of the present application, there is provided with a sidelink transmission method, including:
determining a candidate resource set by a first device on an unlicensed frequency band;
selecting a transmission resource in the candidate resource set;
determining a listen before talk (LBT) class for a sidelink transmission; and
transmitting sidelink information on the transmission resource when listen before talk performed according to the listen before talk class is successful.

According to another aspect of the embodiments of the present application, there is provided with a sidelink transmission apparatus, including:
a first determining unit configured to determine a candidate resource set on an unlicensed frequency band;
a selecting unit configured to select a transmission resource in the candidate resource set;
a second determining unit configured to determine a listen before talk (LBT) class for a sidelink transmission; and
a transmitting unit configured to transmit sidelink information on the transmission resource when listen before talk performed according to the listen before talk class is successful.

According to another aspect of the embodiments of the present application, there is provided with a communication system, including:
a terminal equipment configured to determine a candidate resource set on an unlicensed frequency band; select a transmission resource in the candidate resource set; determine a listen before talk class for a sidelink transmission; and transmit sidelink information on the transmission resource when listen before talk performed according to the listen before talk class is successful.

One of advantages of the embodiments of the present application is in: through determining a candidate resource set on an unlicensed frequency band; selecting a transmission resource in the candidate resource set; determining a listen before talk (LBT) class for a sidelink transmission; and transmitting sidelink information on the transmission resource when listen before talk (LBT) performed according to the LBT class is successful, a device using sidelink communication is able to efficiently perform competition and use unlicensed frequency bands, and coexist fairly with other devices using the unlicensed frequency bands.

With reference to the specification and drawings below, a specific embodiment of the present application is disclosed in detail, which specifies the manner in which the principle of the present application can be adopted. It should be understood that, the scope of the embodiments of the present application is not limited. Within the scope of the spirit and clause of the appended claims, the embodiments of the present application include many variations, modifications and equivalents.

The features described and/or shown for one embodiment can be used in one or more other embodiments in the same or similar manner, can be combined with the features in other embodiments or replace the features in other embodiments.

It should be emphasized that, the term “include/comprise” refers to, when being used in the text, existence of features, parts, steps or assemblies, without exclusion of existence or attachment of one or more other features, parts, steps or assemblies.

### BRIEF DESCRIPTION OF THE DRAWINGS

Elements and features described in one of the drawings or embodiments of the present application may be combined with the elements and features shown in one or more other drawings or embodiments. Moreover, in the drawings, similar reference signs indicate corresponding parts in several drawings and may be used to indicate corresponding parts used in more than one embodiment.

FIG. 1 is a schematic diagram of a communication system in the embodiments of the present application;

FIG. 2 is a schematic diagram of COT sharing;

FIG. 3 is a schematic diagram of performing transmission based on interlacing;

FIG. 4 is a schematic diagram of a sidelink transmission method in the embodiments of the present application;

FIG. 5 is an example diagram of resource selection in the embodiments of the present application;

FIG. 6 is an example diagram of determining an LBT class in the embodiments of the present application;

FIG. 7 is an example diagram of determining sharing COT in the embodiments of the present application;

FIG. 8 is an example diagram of determining an LBT class based on the preceding transmission in the embodiments of the present application;

FIG. 9 is another example diagram of determining an LBT class based on the preceding transmission in the embodiments of the present application;

FIG. 10 is another example diagram of determining an LBT class based on the preceding transmission in the embodiments of the present application;

FIG. 11 is another example diagram of determining an LBT class based on the preceding transmission in the embodiments of the present application;

FIG. 12 is another example diagram of determining an LBT class based on the preceding transmission in the embodiments of the present application;

FIG. 13 is another example diagram of determining an LBT class based on the preceding transmission in the embodiments of the present application;

FIG. 14 is a schematic diagram of a sidelink transmission apparatus in the embodiments of the present application;

FIG. 15 is a schematic diagram of the network device in the embodiments of the present application; and

FIG. 16 is a schematic diagram of a terminal equipment in the embodiments of the present application.

### DETAILED DESCRIPTION

With reference to the drawings, the foregoing and other features of the present application will become apparent through the following description. The Description and drawings specifically disclose the particular embodiment of the present application, showing part of the embodiments in which the principle of the present application can be adopted, it should be understood that the present application is not limited to the described embodiment, on the contrary, the present application includes all modifications, variations and equivalents that fall within the scope of the appended claims.

In embodiments of the present application, the terms “first”, “second”, etc., are used to distinguish different elements by their appellation, but do not indicate the spatial arrangement or chronological order of these elements, etc., and these elements shall not be limited by the terms. The term “and/or” includes any and all combinations of one or more of the terms listed in association with the term. The terms “contain”, “include”, “have”, etc., refer to the presence of the stated feature, element, component or assembly, but do not exclude the presence or addition of one or more other features, elements, components or assemblies.

In the embodiments of the present application, the singular forms “one”, “the”, etc., including the plural forms, shall be broadly understood as “a sort of” or “a kind of” and not limited to the meaning of “one”; furthermore, the term “said” shall be understood to include both the singular form and the plural form, unless it is expressly indicated otherwise in the context. In addition, the term “according to” should be understood to mean “at least partially according to . . . ”, and the term “based on” should be understood to mean “based at least partially on . . . ”, unless it is expressly indicated otherwise in the context.

In embodiments of the present application, the term “communications network” or “wireless communications network” may refer to a network that complies with any of the following communication standards, such as Long Term Evolution (LTE), Enhanced Long Term Evolution (LTE-A), Wideband Code Division Multiple Access (WCDMA), High-Speed Packet Access (HSPA), etc.

In addition, the communication between the devices in the communication system can be carried out according to the communication protocol of any stage, for example, including but not being limited to 1G (generation), 2G, 2.5G, 2.75G, 3G, 4G, 4.5G and 5G, New Radio (NR), etc., and/or other communication protocols currently known or to be developed in the future.

In the embodiments of the present application, the term “network device” refers to, for example, a device in the communication system that connects a terminal equipment to the communication network and provides services to the terminal equipment. The network device may include but is not limited to: a base station (BS), an access point (AP), a transmission reception point (TRP), a broadcast transmitter, a mobile management entity (MME), a gateway, a server, a radio network controller (RNC), a base station controller (BSC), etc.

The base station may include, but is not limited to, a node B (NodeB or NB), an evolution node B (eNodeB or eNB), 5G base station (gNB), etc., and may also include a remote radio head (RRH), a remote radio unit (RRU), a relay, or a low-power node (such as femto, pico, etc.). And the term “base station” may include some or all of their functions, with each base station providing communication coverage to a specific geographic area. The term “cell” can refer to a base station and/or its coverage area, depending on the context in which the term is used.

In the embodiments of the present application, the term “user equipment” (UE) or “terminal equipment or terminal device” (TE) refers, for example, to a device that is connected to the communication network through the network device and receives network services. The terminal equipment can be fixed or movable, and can also be called a mobile station (MS), a terminal, a subscriber station (SS), an access terminal (AT), a station, etc.

The terminal equipment may include but is not limited to: a cellular phone, a personal digital assistant (PDA), a wireless modem, a wireless communication device, a handheld device, a machine-type communication device, a laptop computer, a cordless phone, a smart phone, a smart watch, a digital camera, etc.

For another example, in scenarios such as Internet of Things (IoT), the terminal equipment may also be a machine or an apparatus that performs monitoring or measurement, and may include, but is not limited to, a machine type communication (MTC) terminal, a vehicle communication terminal, a device to device (D2D) terminal, a machine to machine (M2M) terminal, and etc.

In addition, the term “network side” or “network device side” refers to the side of the network, which may be a base station or may include one or more network devices as described above. The term “user side” or “terminal side” or “terminal equipment side” refers to the side of the user or

terminal, which may be a UE or may include one or more terminal equipments as described above. Without specifically indicated, “device” can refer to a network device or a terminal equipment.

Hereinafter the scenarios of in the embodiments of the present application are illustrated by examples, but the embodiments of this disclosure are not limited thereto.

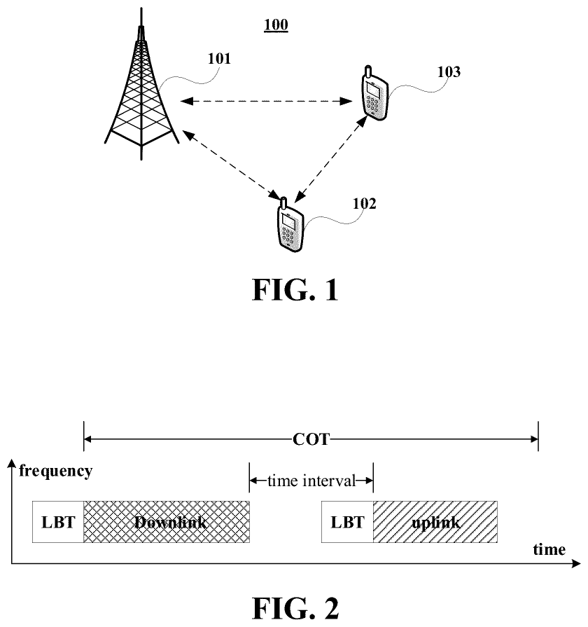

FIG. 1 is a schematic diagram of a communication system in the embodiments of the present application, in which a case where a terminal equipment and a network device are taken as an example is schematically shown. As shown in FIG. 1, a communication system 100 may include a network device 101 and terminal equipments 102 and 103. For simplicity, FIG. 1 illustrates only two terminal equipments and one network device as examples, but the embodiments of this disclosure are not limited thereto.

In the embodiments of the present application, existing services or services that may be implemented in the future may be transmitted between the network device 101 and the terminal equipments 102, 103. For example, these services may include, but are not limited to, enhanced Mobile Broadband (eMBB), massive Machine Type Communication (mMTC), and Ultra-Reliable and Low-Latency Communication (URLLC).

It is worth noting that FIG. 1 shows that two terminal equipments 102 and 103 are within the coverage of the network equipment 101, but the embodiments of this disclosure are not limited thereto. The two terminal equipments 102 and 103 may not be within the coverage of the network device 101, or one terminal equipment 102 is within the coverage of the network device 101 and the other terminal equipment 103 is outside the coverage of the network device 101.

In the embodiments of the present application, sidelink transmission may be carried out between two terminal equipments 102 and 103. For example, the two terminal equipments 102 and 103 may both perform sidelink transmission within the coverage of the network device 101 to achieve sidelink communication, or may both perform sidelink transmission outside the coverage of the network device 101 to achieve sidelink communication, or one terminal equipment 102 may perform sidelink transmission within the coverage of the network device 101 and the other terminal equipment 103 may perform sidelink transmission outside the coverage of the network device 101 to achieve sidelink communication.

In the 5G stage, 3GPP conducts standardization studies and projects on both sidelink and unlicensed frequency bands, such as NR V2X in Rel-16, sidelink enhancement in Rel-17, and NR-Unlicensed (NR-U) in Rel-16.

NR sidelink defines two resource allocation modes: mode 1 and mode 2. The main steps for the mode 2 resource selection are shown in Table 1. The complete resource selection process may be found in the section 8.1.4 of the standard TS 38.214.

```
TABLE 1
- step 1: a set S_{A} is initialized as a set including all candidate resources R_{x,y}.
- step 2: a device excludes the candidate resource R_{x,y} from the set S_{A}, where R_{x,y} meets
all of the following conditions:
  a) the device receives SCI at the slot tₘ^{SL}; the SCI indicates the receiving prioritization
prio_{RX} and the period Pᵣₛᵥₚ_RX; and Pᵣₛᵥₚ_RX is in the unit of millisecond.
  b) the RSRP values determined on the basis of the SCI are higher than the RSRP
threshold Th(prio_{RX}, prio_{TX}), prio_{TX} is the transmitting prioritization from the higher
layer.
  c) based on the SCI received at the slot tₘ^{SL}, or assuming that the reserved resource
$determined by the SCI that is able to be received at the slot {t}_{m + q \times {P}_{rsvp\_RX}^{′}}^{SL} overlaps$
$candidate resources {R}_{x , y + j \times {P}_{rsvp\_TX}^{′}} ; {P}_{rsvp \_ RX}^{′} represents the converted {P}_{rsvp\_RX} in the$
unit of logical slot; j = 0,1, ... , Cᵣₑₛₑₗ − 1, Cᵣₑₛₑₗ represents the number of cycles the
device needs for transmission, and q = 1,2, ... , Q; if Pᵣₛᵥₚ_RX < T_{scal} and n′ − m ≤
${P}_{rsvp\_RX}^{′} , Q = ⌈ \frac{{T}_{scal}}{{P}_{rsvp \_ RX}} ⌉ ; otherwise , Q = 1 ; n is the slot that higher layer triggers the$
device for performing resource selection; if the slot n is a slot included in the resource
pool, t_{n′}^{SL} = n; otherwise, t_{n′}^{SL} is the first slot that is posterior to the slot n and included
in the resource pool, T_{scal} represents the converted T₂ in the unit of millisecond, and T₂ is
the length of the resource selection window.
- step 3: the device determines whether the number of candidate resources in the set S_{A} is
smaller than the threshold of the number of the resources; if it is, the RSRP threshold
Th(pᵢ, pⱼ) is increased by 3 dB for all receiving prioritization pᵢ and the transmitting
prioritization pⱼ, and execution continues from the beginning of the step 1; if it is not, the
device reports the set S_{A} to the higher layer.
```

3GPP further enhances NR sidelink resource allocation in Rel-17, including power saving and inter-UE coordination. The application scenario also extends to public safety and business-related services.

In another aspect, in order to enable 5G technology to use unlicensed spectrum (bands), 3GPP completes the standardization of NR-based unlicensed access (NR-U) in Rel-16. The use of unlicensed frequency bands needs to comply with regulatory rules in different countries and regions. To this end, NR-U supports some new characteristics on the basis of NR, including Listen Before Talk (LBT), Channel Occupancy Time (COT), COT sharing, interlacing-based transmission, and so on.

In order to ensure the fair coexistence with WIFI and other systems, access to the unlicensed frequency band needs to detect and evaluate a channel using LBT, and only when the channel is idle (LBT is successful), the channel access opportunity may be obtained for transmission. NR-U defines three LBT processes, including Cat1 LBT (LBT Class 1), Cat2 LBT (LBT Class 2), and Cat4 LBT (LBT Class 4). Channel detection may not be performed in the Cat1 LBT. Cat2 LBT includes Cat2 16 μs LBT and Cat2 25 μs LBT and undergoes 16 μs channel detection and 25 μs channel detection before transmitting data. Cat4 LBT includes variable number of times of channel detection. The higher the level of LBT is, the more strict the conditions for LBT success is.

In order to occupy the channel more efficiently, the device (base station) may share the COT obtained by the base station (device), which is called COT sharing. The device or the base station may use a low class of LBT when sharing the COT, thereby avoiding the use of the highest level of LBT for each transmission, and achieving the effect of reducing transmission delay.

FIG. 2 is a schematic diagram of COT sharing, schematically showing COT sharing. For example, the base station occupies the channel via Cat4 LBT, performs downlink data/information transmission, and transmits a COT indication, that is, initiates the COT. The COT indication may indicate the COT duration, the LBT bandwidth supported within the COT, the uplink and downlink data structures within the COT, and the like.

If the time interval between the uplink transmission of the device and the previous downlink transmission of the base station is less than 16 μs, the base station may instruct the device to transmit data via Cat1 LBT. If the time interval between the uplink transmission of the device and the previous downlink transmission of the base station is equal to 16 μs or 25 μs, the base station may instruct the device to transmit data via Cat2 16 μs LBT or Cat2 25 μs LBT. If the device knows that a transmission is within the COT initiated by the base station based on the COT indication, the device may also adjust the LBT class of uplink transmission according to the time interval of the uplink and downlink data, for example from Cat4 LBT to Cat2 LBT.

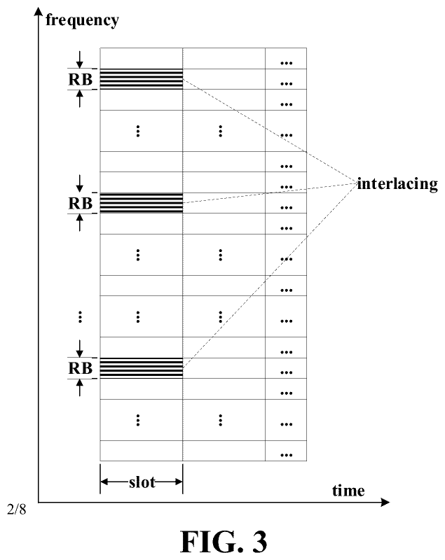

In order to meet the requirements of regulatory rules on the channel bandwidth occupancy, the PUSCH and PUCCH of NR-U perform transmission based on the mode of frequency domain interlacing. FIG. 3 is a schematic diagram of performing transmission based on interlacing, schematically showing the interlacing. As shown in FIG. 3, an interlacing includes several resource blocks (RB) that are discrete in the frequency domain, and the discrete RBs are evenly spaced in the frequency domain. One or more interlacings may be used in one transmission.

For Cat4 LBT, a channel access priority class (CAPC) is used to determine the relevant parameters required for the LBT process, such as the maximum channel occupancy time, and the length of the competition window. Table 2 schematically shows the uplink channel access priority class. The smaller the CAPC value p is, the higher the channel access priority class is. The device needs to know which CAPC value is to be used when performing Cat4 LBT.

TABLE 2

| CAPC | | | | | allowed CWₚ |
|---|---|---|---|---|---|
| (p) | mₚ | CW_{min, p} | CW_{max, p} | T_{ulmcot, p} | sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

In the following description, without causing confusion, the terms “sidelink” and “V2X” are interchangeable, the terms “PSFCH” and “sidelink feedback channel” are interchangeable, the terms “PSCCH” and “sidelink control channel” or “sidelink control information” are interchangeable, and the terms “PSSCH” and “sidelink data channel” or “sidelink data” are also interchangeable.

In addition, transmitting or receiving PSCCH may be understood as transmitting or receiving the sidelink control information carried by PSCCH; transmitting or receiving PSSCH may be understood as transmitting or receiving sidelink data carried by PSSCH; and, transmitting or receiving PSFCH may be understood as transmitting or receiving sidelink feedback information carried by PSFCH. Sidelink transmission (also known as sidelink transmission) may be understood as PSCCH/PSSCH transmission or sidelink data/information transmission.

In the embodiments of the present application, the time unit may have any time length, such as frame, sub-frame, slot, mini-slot, and hereinafter the slot is taken as an example for description. The PSCCH/PSSCH may also be shortened as PSSCH, and SCI may refer to 1st stage SCI and/or 2nd stage SCI. The sidelink information includes sidelink control information and/or data information and/or feedback information.

### Embodiments of First Aspect

The embodiments of the present application provide a sidelink transmission method, which is explained from the side of a first device.

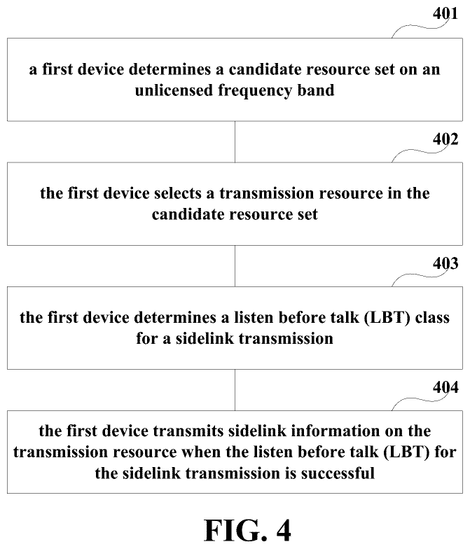

FIG. 4 is a schematic diagram of a sidelink transmission method in the embodiments of the present application. As shown in FIG. 4, the method includes:
401, a first device determines a candidate resource set on an unlicensed frequency band;
402, the first device selects a transmission resource in the candidate resource set;
403, the first device determines a listen before talk (LBT) class for a sidelink transmission; and
404, the first device transmits sidelink information on the transmission resource when the listen before talk (LBT) for the sidelink transmission is successful.

It is worth noting that FIG. 4 above only schematically illustrates the embodiments of the present application, but the present application is not limited to this. For example, the order of execution between operations may be adjusted appropriately, and some other operations may be added or reduced. Those skilled in the art may make appropriate variations in accordance with the above contents, and which is not limited to the disclosure of FIG. 4 above.

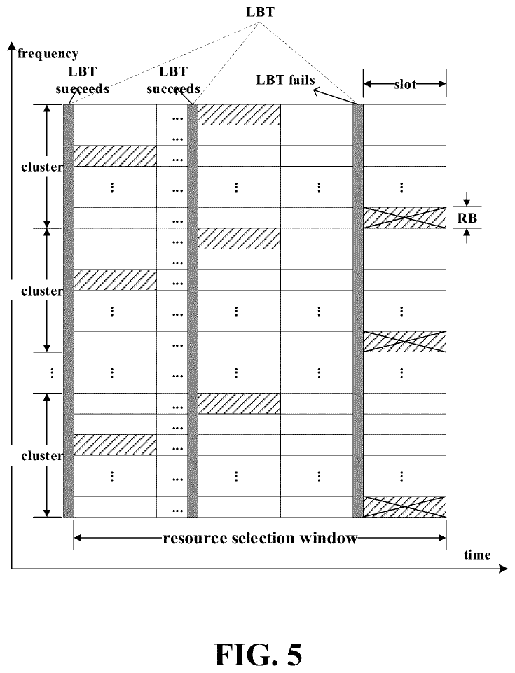

FIG. 5 is an example diagram of resource selection in the embodiments of the present application, schematically showing the process in which the device performs transmission in the unlicensed frequency band based on autonomous resource selection (mode 2). The device determines the candidate resource set S_{A}. For example, the device treats one or more interlacings as one candidate resource and then reuses the mode 2 resource selection method to determine the candidate resource set S_{A} according to the section 8.1.4 of the standard TS 38.214.

As shown in FIG. 5, for example, S_{A} includes several candidate resources in the resource selection window. The physical layer of the device reports the S_{A} to the higher layer (for example, an MAC layer). The higher layer selects one or more candidate resources from the S_{A}. For example, the device reuses the mode 2 resource selection method to select candidate resources according to the section 5.22.1.1 of the standard TS 38.321. In FIG. 5, the candidate resources selected by the device are shaded and are used to transmit sidelink information (PSCCH/PSSCH).

The device needs to perform LBT before transmission, and whether the device may practically perform transmission depends on an LBT result. The device determines the LBT class for each transmission, such as Cat1 LBT, Cat2 LBT, or Cat4 LBT. The device performs corresponding LBT according to the LBT class. The device performs transmission when the LBT succeeds and does not perform transmission when the LBT fails. For example, as shown in FIG. 5, the device does not perform transmission in the last slot of the resource selection window due to the LBT failure.

In some embodiments, the first device determines the LBT class based on whether the sidelink transmission is within the channel occupancy time (COT). The LBT class may include, for example, Cat1 LBT (LBT Class 1), Cat2 LBT (LBT Class 2) and Cat4 LBT (LBT Class 4), or may include, for example, class 1 and class 2 etc., or may include, for example, type A, type B, type C, and type D etc., the specific forms of expression are not limited in the embodiments of the present application.

In some embodiments, the channel occupancy time (COT) is obtained through the COT indication received by the first device. For example, a second device (or a third device or a fourth device described below) transmits a COT indication to the first device, and the first device obtains the COT according to the COT indication. For ease of description, this type of COT may be called shared COT.

In some embodiments, the channel occupancy time (COT) is obtained by the first device performing listen before talk (LBT). For example, the first device may obtain the COT by performing Cat4 LBT (high class LBT) successfully by itself, and for the specific content of LBT and COT, reference may be made to the relevant technology in NR-U. For ease of description, this type of COT may be called the initiated COT.

In some embodiments, the first device transmits a COT indication that includes information about the channel occupancy time (COT). For example, after the first device obtaining the COT by performing Cat4 LBT successfully by itself, the first device may transmit sidelink information within the COT through the resource selection process, and the first device may also transmit to other devices the COT indication including the COT information.

In some embodiments, the LBT class is determined to be low class or high class in the case where the sidelink transmission is within the channel occupancy time (COT).

In some embodiments, the LBT class is determined to be high class in the case where the sidelink transmission is outside the channel occupancy time (COT).

For example, when the device determines the LBT class for certain transmission, it may be known whether the transmission is currently within the COT. The device may determine the LBT class using this information. For example, the LBT class determined for the transmission outside the COT is Cat4 LBT, and the LBT class determined for the transmission inside the COT is Cat1 LBT or Cat2 LBT or Cat4 LBT.

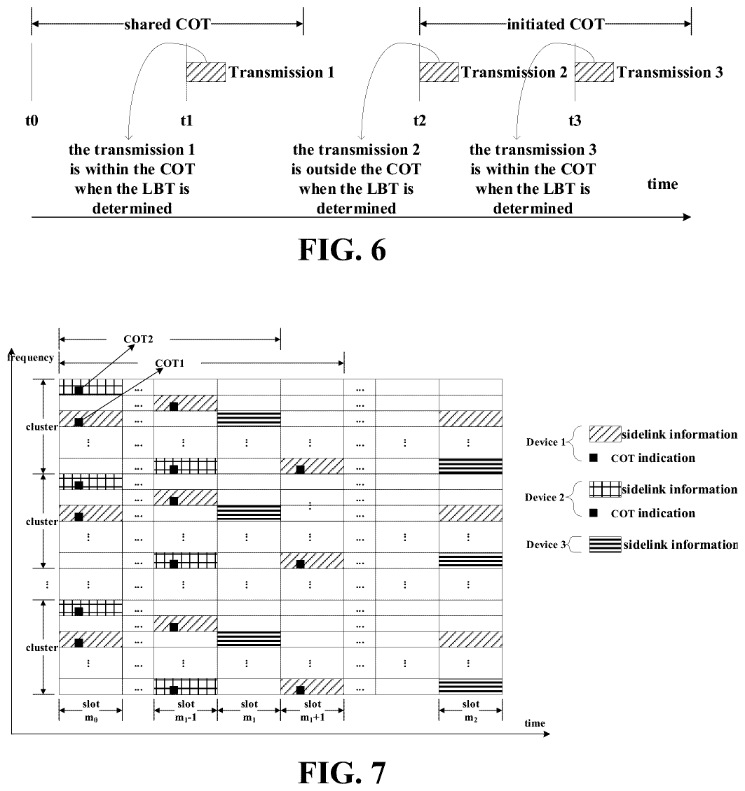

FIG. 6 is an example diagram of determining the LBT class in the embodiments of the present application, a schematic explanation is provided to determine, by a device, whether the transmission is within the COT. FIG. 6 gives illustration from the point of view of a single device, and all the transmissions in FIG. 6 belong to the same device. For simplicity, interlacing is simplified in FIG. 6.

As shown in FIG. 6, the COT includes the shared COT and the initiated COT. The first device may initiate the COT (starting at t2) by transmission (transmission 2) when the Cat4 LBT succeeds, and may continue to perform transmission (transmission 3) within the COT. The COT is called the initiated COT. The first device may also share the COT initiated by the second device (starting at t0), that is, perform transmission (transmission 1) within the COT initiated by the second device. From the point of view of the first device, the COT is called a shared COT. Transmission within the COT means transmission within the shared COT or within the initiated COT.

In addition, whether the transmission is within the COT refers to what the device observes when the LBT is determined. The device needs to determine the LBT class for itself before transmission. The device obtains the shared COT at t0, for example by receiving a COT indication. The device determines the LBT class for the transmission 1 before t1, and before t1, the device observes that the transmission 1 is within the shared COT. The device determines the LBT class for the transmission 2 before t2, and although the transmission 2 is within the initiated COT after t2, the device has not initiated the COT before t2, hence the device observes that the transmission 2 is outside the COT at this point. After the LBT is successful, the device performs the transmission 2 at t2 and initiates the COT, such as transmitting the COT indication. The device determines the LBT class for the transmission 3 before t3, and before t3, the device observes that the transmission 3 is within the initiated COT.

Determination of the LBT class according to the COT is schematically illustrated hereinbefore, and the shared COT is explained below.

In some embodiments, the first device receives one or more COT indications indicating first channel occupancy times (COT); and determines a second channel occupancy time (COT) for obtaining a listen before talk (LBT) class, according to one or more channel occupancy times (COT) and/or the channel occupancy time (COT) obtained by performing the LBT.

For example, in sidelink communication, the device may receive more than one COT indications, thereby obtaining a plurality of COTs. However, not all COTs are suitable for being used in COT sharing.

In some embodiments, the second channel occupancy time (COT) for obtaining the LBT class is indicated by a COT indication transmitted by a second device, a first device and the second device satisfying at least one of the following conditions (a first condition):
reference signal receiving power (RSRP) between the first device and the second device is greater than a first threshold;
a distance between the first device and the second device is less than a second threshold;
the first device is a transmitter of sidelink information of the second device;
the first device is a receiver of the sidelink information of the second device;
the first device and the second device have identical cast types; or
a channel access priority class (CAPC) value of the first device is less than a channel access priority class (CAPC) value of the second device.

For example, if the LBT results of the two devices are different, it is not suitable for sharing the COT between the two devices, thus it may be determined whether the COT is shared or not according to the RSRP and/or distance between the two devices.

For another example, a device in one unicast pair may not be suitable for sharing a COT initiated by a device in another unicast pair, thus it may be determined whether the COT is shared or not according to whether the two devices belong to the same pair of transmitting and receiving devices.

For another example, a unicast device may not be suitable for sharing a COT initiated by a broadcast device, thus it may be determined whether the COT is shared or not according to whether the two devices have the same cast type.

For another example, a device with a low channel access priority class (CAPC) may not be suitable for sharing a COT initiated by a device with a high channel access priority class (CAPC), thus it may be determined whether the COT is shared or not according to the channel access priority class (CAPC) value.

For another example, it may be determined whether the COT is shared or not according to any combination of the above conditions.

Here, “the device 1 is a transmitter of the device 2” means that the destination ID of the device 1 is the ID that the device 2 is interested in. For example, the device 1 is a transmitter of unicast and the device 2 is a receiver of unicast. For another example, the device 1 and the device 2 are members belonging to the same group in multicast, and the destination ID of the device 1 is the group ID. The meaning of “the device 1 is the receiver of the device 2” may be obtained by the same token.

FIG. 7 is an example diagram of sharing COT in the embodiments of the present application, a schematic explanation is provided to determine, by a device, whether the transmission is within the shared COT. As shown in FIG. 7, the device 3 receives the COT indication transmitted by the device 1 at the slot m₀, to obtain COT duration COT 1. Similarly, the device 3 receives the COT indication transmitted by the device 2 at the slot m₀, to obtain COT duration COT 2. For the device 1 and the device 2, only device 3 and the device 1 meet at least one of the following conditions (condition 1):
the RSRP between the device 3 and the device 1 is greater than the threshold;
the distance between the device 3 and the device 1 is smaller than the threshold;
the device 3 is a transmitter of the device 1;
the device 3 is a receiver of the device 1;
the device 3 has the same cast type as the device 1; or
the CAPC value of the device 3 is smaller than that of the device 1.

Therefore, COT 1 is a shared COT, and the transmission of the device 3 in the slot mi is in COT 1. If the device 1 and COT 1 do not exist in FIG. 7, the transmission in the slot mi is determined not to be in any COT, that is, COT 2 is not a COT that may be shared for the device 3.

The first device may obtain the information needed to determine the condition in the following ways. The RSRP is equal to the RSRP of the PSCCH/PSSCH carrying the COT indication. The 2nd stage SCI may indicate the zone ID, whereby the first device may calculate the distance from the second device. The 2nd stage SCI may indicate Source ID and Destination ID, so that the first device may determine whether the second device is its receiver or transmitter. The cast type indicator field of the 2nd stage SCI indicates the cast type, from which the first device may obtain the cast type of the second device. The first device may also obtain the cast type of the second device based on the 2nd stage SCI format (SCI format 2-A or SCI format 2-B), where SCI format 2-B denotes multicast. The second device indicates the CAPC value by transmitting signaling. For example, the 1st stage SCI or 2nd stage SCI carries the CAPC value. The smaller the CAPC value is, the higher the channel access priority class is.

Hereinafter, the case where the LBT class is determined based on sidelink transmission is further schematically illustrated.

In some embodiments, the sidelink transmission is a first transmission within the channel occupancy time (COT), and the first device determines the LBT class for the first transmission according to a second transmission prior to the first transmission.

In some embodiments, the LBT class is determined as a low class when a time interval between the first transmission and the second transmission is less than a threshold.

In some embodiments, the LBT class is determined as a high class when a time interval between the first transmission and the second transmission is greater than or equal to a threshold.

In some embodiments, the second transmission includes at least one of the following:
a sidelink transmission of a first device;
a sidelink transmission of the third device transmitting a COT indication for indicating the channel occupancy time (COT); or
a sidelink transmission of a fourth device not transmitting the COT indication for indicating the channel occupancy time (COT).

For example, for transmission within the COT, the device may use a low class of LBT (Cat1 LBT, Cat2 LBT). The device determines the LBT class based on the preceding transmission.

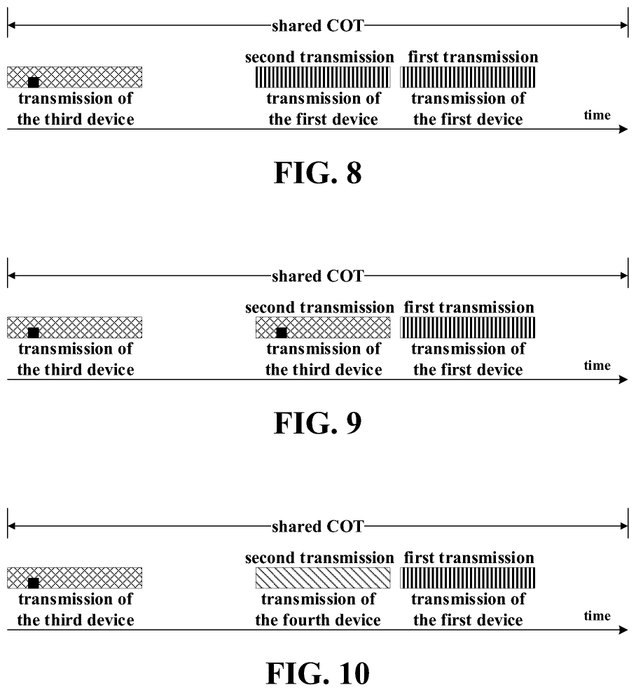

FIG. 8 is an example diagram of determining the LBT class based on the preceding transmission in the embodiments of the present application, FIG. 9 is another example diagram of determining the LBT class based on the preceding transmission in the embodiments of the present application, FIG. 10 is another example diagram of determining the LBT class based on the preceding transmission in the embodiments of the present application. FIGS. 8 to 10 schematically illustrate determination of LBT class for the transmission within the shared COT.

As shown in FIG. 8, the first device shares the COT initiated by the third device, the first device performs multiple number of times of transmission in the COT, and the first device determines the LBT class for the first transmission according to the second transmission. The third device is a device that transmits the COT indication.

For example, the first device may use Cat1 LBT or Cat2 LBT if the time interval between the end moment of the second transmission and the start moment of the first transmission is small enough. For example, Cat1 LBT is used when the time interval is less than 16 μs. For example, Cat2 16 μs LBT is used when the time interval is equal to 16 μs. For example, Cat2 25 μs LBT is used when the time interval is equal to 25 μs.

As shown in FIG. 9, the first device shares the COT initiated by the third device, and the first device determines the LBT class for the first transmission according to the transmission of the third device (the second transmission). As shown in FIG. 9, the third device is a device that transmits the COT indication, and the first device shares the COT initiated by the third device. In addition, the first device may know the time-domain position where the second transmission is located based on the received PSCCH/PSSCH transmitted by the third device.

For example, the first device may use Cat1 LBT or Cat2 LBT if the time interval between the end moment of the second transmission and the start moment of the first transmission is small enough. For example, Cat1 LBT is used when the time interval is less than 16 μs. For example, Cat2 16 μs LBT is used when the time interval is equal to 16 μs. For example, Cat2 25 μs LBT is used when the time interval is equal to 25 μs.

As shown in FIG. 10, the first device shares the COT initiated by the third device, and the first device determines the LBT class for the first transmission according to the transmission of the fourth device (the second transmission), wherein the fourth device is a device that does not transmit the COT indication. As shown in FIG. 10, the third device is a device that transmits the COT indication. In addition, the first device may know the time-domain position where the second transmission is located based on the received PSCCH/PSSCH transmitted by the fourth device.

For example, the first device may use Cat1 LBT or Cat2 LBT if the time interval between the end moment of the second transmission and the start moment of the first transmission is small enough. For example, Cat1 LBT is used when the time interval is less than 16 μs. For example, Cat2 16 μs LBT is used when the time interval is equal to 16 μs. For example, Cat2 25 μs LBT is used when the time interval is equal to 25 μs.

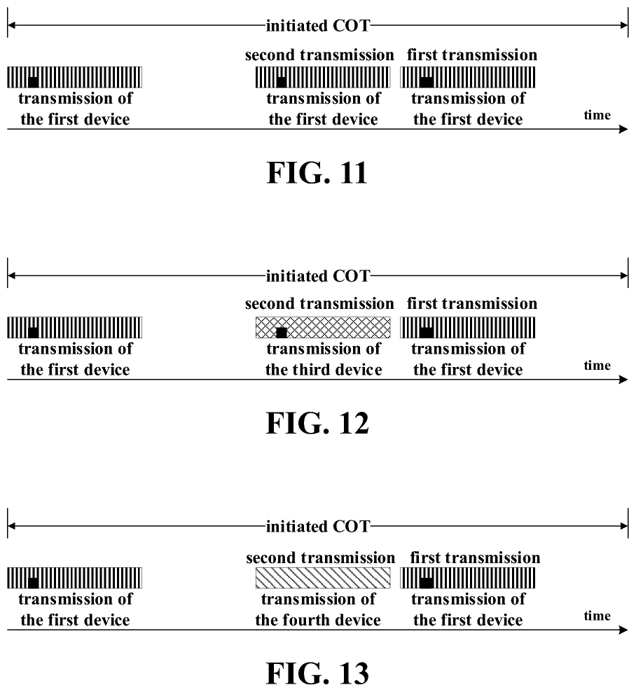

FIG. 11 is another example diagram of determining the LBT class based on the preceding transmission in the embodiments of the present application, FIG. 12 is another example diagram of determining the LBT class based on the preceding transmission in the embodiments of the present application, and FIG. 13 is another example diagram of determining the LBT class based on the preceding transmission in the embodiments of the present application. FIGS. 11 to 13 schematically illustrate determination of LBT class for the transmission within the initiated COT.

As shown in FIG. 11, the first device initiates the COT, the first device performs multiple number of times of transmission in the COT, and the first device determines the LBT class for the first transmission according to the second transmission. For example, the first device may use Cat1 LBT or Cat2 LBT if the time interval between the end moment of the second transmission and the start moment of the first transmission is small enough. For example, Cat1 LBT is used when the time interval is less than 16 μs. For example, Cat2 16 μs LBT is used when the time interval is equal to 16 μs. For example, Cat2 25 μs LBT is used when the time interval is equal to 25 μs.

As shown in FIG. 12, the first device initiates the COT, and the first device determines the LBT class for the first transmission according to the transmission of the third device (the second transmission). As shown in FIG. 12, the third device is a device that transmits the COT indication. In addition, the first device may know the time-domain position where the second transmission is located based on the received PSCCH/PSSCH transmitted by the third device.

For example, the first device may use Cat1 LBT or Cat2 LBT if the time interval between the end moment of the second transmission and the start moment of the first transmission is small enough. For example, Cat1 LBT is used when the time interval is less than 16 μs. For example, Cat2 16 μs LBT is used when the time interval is equal to 16 μs. For example, Cat2 25 μs LBT is used when the time interval is equal to 25 μs.

As shown in FIG. 13, the first device initiates the COT, and the first device determines the LBT class for the first transmission according to the transmission of the fourth device (the second transmission). As shown in FIG. 13, the fourth device is a device that does not transmit the COT indication. In addition, the first device may know the time-domain position where the second transmission is located based on the received PSCCH/PSSCH transmitted by the fourth device.

For example, the first device may use Cat1 LBT or Cat2 LBT if the time interval between the end moment of the second transmission and the start moment of the first transmission is small enough. For example, Cat1 LBT is used when the time interval is less than 16 μs. For example, Cat2 16 μs LBT is used when the time interval is equal to 16 μs. For example, Cat2 25 μs LBT is used when the time interval is equal to 25 μs.

In some embodiments, the device may use Cat4 LBT for the transmission within the COT, and when the above conditions for using a lower class of LBT are met, the device uses Cat1 LBT or Cat2 LBT. For transmission within the COT, the device can achieve switching from Cat4 LBT to Cat1 LBT or Cat2 LBT.

In some embodiments, the first device and the third device meet at least one of the following conditions:
the RSRP between the first device and the third device is greater than the first threshold;
a distance between the first device and the third device is less than a second threshold;
the first device is a transmitter of sidelink information of the third device;
the first device is a receiver of the sidelink information of the third device;
the first device and the third device have identical cast types; or
a channel access priority class (CAPC) value of the first device is less than a channel access priority class (CAPC) value of the third device.

For example, not all preceding transmissions are suitable for being used for determining the LBT class, and when the first device determines the LBT class based on the preceding transmissions of other devices, it may further be restricted that the first device and other devices meet at least one condition. For example, in FIGS. 8 to 13, the first device and the third device meet at least one of the above conditions.

In some embodiments, the first device and the fourth device meet at least one of the following conditions:
the RSRP between the first device and the fourth device is greater than the first threshold;
a distance between the first device and the fourth device is less than a second threshold;
the first device is a transmitter of sidelink information of the fourth device;
the first device is a receiver of the sidelink information of the fourth device;
the first device and the fourth device have identical cast types; or
a channel access priority class (CAPC) value of the first device is less than a channel access priority class (CAPC) value of the fourth device.

For example, not all preceding transmissions are suitable for being used for determining the LBT class, and when the first device determines the LBT class based on the preceding transmissions of other devices, it can further be restricted that the first device and other devices meet at least one condition. For example, in FIGS. 8 to 13, the first device and the fourth device meet at least one of the above conditions.

In some embodiments, the second transmission and the first transmission are within identical channel occupancy times (COT).

For example, as shown in FIGS. 8 to 13, the second transmission and the first transmission are within the same COT (shared COT and/or initiated COT).

In some embodiments, the frequency at which the first device monitors the physical sidelink control channel (PSCCH) outside the channel occupancy time (COT) is higher than the frequency at which the first device monitors the physical sidelink control channel (PSCCH) inside the channel occupancy time (COT).

For example, the device needs to monitor the PSCCH to receive data. According to the method described above, the device may determine whether a certain monitoring moment is within the COT. The device may use this information to determine the behavior of monitoring the PSCCH. Affected by LBT, the transmission outside the COT is more uncertain, thus the device may monitor the PSCCH more frequently outside the COT.

For example, the device periodically monitors the PSCCH, and the period that the device monitors the PSCCH outside the COT is smaller than the period that the device monitors the PSCCH inside the COT. For example, in unit time (one or more slots), the number of times the device monitors PSCCH outside the COT is H1 and the number of times the device monitors PSCCH inside the COT is H2, and H1>H2.

In other words, the frequency at which the device monitors PSCCH outside the COT is higher than the frequency at which the device monitors PSCCH inside the COT. For example, “frequency” here refers to the number of times per unit time, which is different from “frequency” in “time frequency resource”.

Hereinbefore the embodiments of the present application is explained from the point of view of the first device, and for other devices (the second device to the fourth device as described above), operations the same as or corresponding to that of the first device may be performed for the first device.

For example, the second device performs listen before talk (LBT) on the unlicensed frequency band; obtains the channel occupancy time (COT) according to the listen before talk (LBT); and transmits a COT indication that includes information about the channel occupancy time (COT).

In addition, for the convenience of description above, the device receiving the COT indication is the first device, and the device transmitting the COT indication includes the second device to the fourth device. The second device to the fourth device in the embodiments of the present application may be the same one device, or may be different multiple devices, which is not limited in the embodiments of the present application.

The embodiments above only schematically illustrate the embodiments of the present application, but the present application is not limited to this, and appropriate variations can also be made on the basis of the above embodiments. For example, the above embodiments may be used separately, or one or more of the above embodiments may be combined.

As can be seen from the above embodiments, through determining a candidate resource set on an unlicensed frequency band; selecting a transmission resource in the candidate resource set; determining a listen before talk (LBT) class for a sidelink transmission; and transmitting sidelink information on the transmission resource when listen before talk (LBT) performed according to the LBT class is successful, a device using sidelink communication is able to efficiently perform competition and use unlicensed frequency bands, and may coexist fairly with other devices using the unlicensed frequency bands.

### Embodiments of Second Aspect

The embodiments of the present application provide a sidelink transmission apparatus. The apparatus may be, for example, a terminal equipment (such as a first device described above), or one or more parts or components configured in the terminal equipment, and the same content as the embodiments of the first aspect will not be repeated.

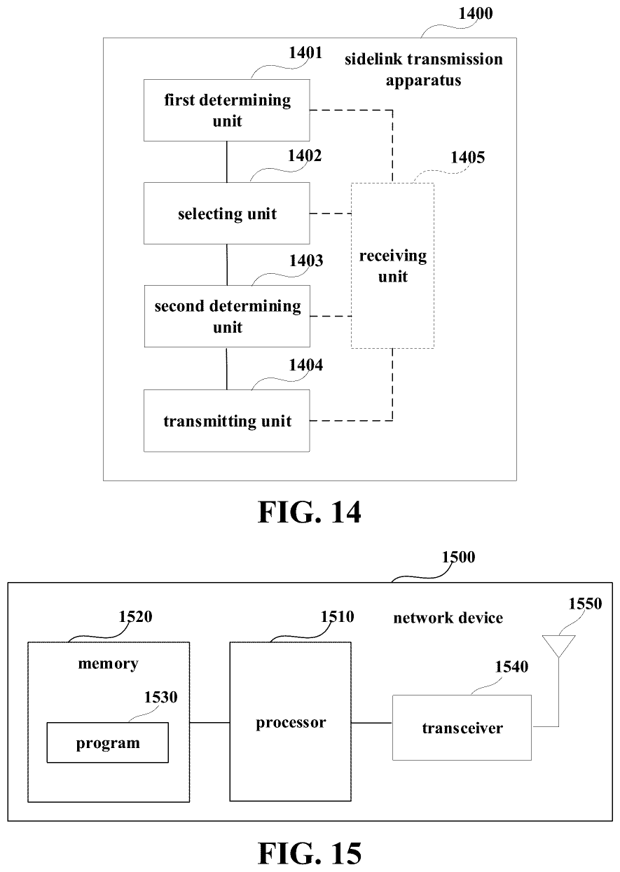

FIG. 14 is a schematic diagram of a sidelink transmission apparatus in the embodiments of the present application. As shown in FIG. 14, a sidelink transmission apparatus 1400 includes:
a first determining unit 1401 configured to determine a candidate resource set on an unlicensed frequency band;
a selecting unit 1402 configured to select a transmission resource in the candidate resource set;
a second determining unit 1403 configured to determine a listen before talk (LBT) class for a sidelink transmission; and
a transmitting unit 1404 configured to transmit sidelink information on the transmission resource when listen before talk performed according to the listen before talk class is successful.

In some embodiments, the second determining unit 1403 determines the listen before talk class according to whether the sidelink transmission is within a channel occupancy time (COT).

In some embodiments, when the sidelink transmission is within the channel occupancy time, the listen before talk class is determined as a low class or a high class.

In some embodiments, when the sidelink transmission is outside the channel occupancy time, the listen before talk class is determined as a high class.

In some embodiments, the channel occupancy time is obtained via a COT indication received by a first device.

In some embodiments, the channel occupancy time is obtained by performing listen before talk by the first device.

In some embodiments, the first device obtains the channel occupancy time by performing the listen before talk according to a high-class listen before talk.

In some embodiments, as shown in FIG. 14, the sidelink transmission apparatus 1400 further includes:
a receiving unit 1405 configured to receive one or more COT indications indicating first channel occupancy times;
and the second determining unit 1403 is further configured to determine a second channel occupancy time for obtaining the listen before talk class, according to one or more channel occupancy times and/or the channel occupancy time obtained by performing listen before talk.

In some embodiments, the second channel occupancy time for obtaining the listen before talk class is indicated by a COT indication transmitted by a second device, a first device and the second device satisfying at least one of the following conditions:
the RSRP between the first device and the second device is greater than the first threshold;
a distance between the first device and the second device is less than a second threshold;
the first device is a transmitter of sidelink information of the second device;
the first device is a receiver of the sidelink information of the second device;
the first device and the second device have identical cast types; or
a channel access priority class value of the first device is less than a channel access priority class value of the second device.

In some embodiments, the sidelink transmission is a first transmission within the channel occupancy time, and the first device determines the listen before talk class for the first transmission according to a second transmission prior to the first transmission.

In some embodiments, the listen before talk class is determined as a low class when a time interval between the first transmission and the second transmission is less than a threshold.

In some embodiments, the listen before talk class is determined as a high class when a time interval between the first transmission and the second transmission is greater than or equal to a threshold.

In some embodiments, the second transmission includes at least one of the following:
a sidelink transmission of a first device;
a sidelink transmission of the third device transmitting a COT indication for indicating the channel occupancy time; or
a sidelink transmission of a fourth device not transmitting the COT indication for indicating the channel occupancy time.

In some embodiments, the first device and the third device meet at least one of the following conditions:
the RSRP between the first device and the third device is greater than the first threshold;
a distance between the first device and the third device is less than a second threshold;
the first device is a transmitter of sidelink information of the third device;
the first device is a receiver of the sidelink information of the third device;
the first device and the third device have identical cast types; or
a channel access priority class value of the first device is less than a channel access priority class value of the third device.

In some embodiments, the first device and the fourth device meet at least one of the following conditions:
the RSRP between the first device and the fourth device is greater than the first threshold;
a distance between the first device and the fourth device is less than a second threshold;
the first device is a transmitter of sidelink information of the fourth device;
the first device is a receiver of the sidelink information of the fourth device;
the first device and the fourth device have identical cast types; or
a channel access priority class value of the first device is less than a channel access priority class value of the fourth device.

In some embodiments, the second transmission and the first transmission are within identical channel occupancy times.

In some embodiments, a frequency of monitoring a physical sidelink control channel outside the channel occupancy time is greater than a frequency of monitoring a physical sidelink control channel within the channel occupancy time.

The embodiments above only schematically illustrate the embodiments of the present application, but the present application is not limited to this, and appropriate variations can also be made on the basis of the above embodiments. For example, the above embodiments may be used separately, or one or more of the above embodiments may be combined.

It is worth noting that only the components or modules related to the present application are illustrated hereinabove, but the present application is not limited to this. The sidelink transmission apparatus 1400 may further include other components or modules, and the details of these components or modules can be seen by referring to the related art.

In addition, for the sake of simplicity, FIG. 14 only exemplarily shows the connection relationship or signal trend between the individual components or modules, but it should be clear to those skilled in the art that various related techniques such as bus connections can be employed. The above individual components or modules may be implemented by hardware facilities such as a processor, a memory, a transmitter, a receiver, and the embodiments of this disclosure are not limited thereto.

As can be seen from the above embodiments, through determining a candidate resource set on an unlicensed frequency band; selecting a transmission resource in the candidate resource set; determining a listen before talk (LBT) class for a sidelink transmission; and transmitting sidelink information on the transmission resource when listen before talk (LBT) performed according to the LBT class is successful, a device using sidelink communication is able to efficiently perform competition and use unlicensed frequency bands, and may coexist fairly with other devices using the unlicensed frequency bands.

### Embodiments of Third Aspect

The embodiments of the present application further provide a communication system, referring to FIG. 1, the same content as the embodiments in the first and second aspects will not be repeated.

In some embodiments, the communication system 100 may include at least:
a terminal equipment configured to determine a candidate resource set on an unlicensed frequency band; select a transmission resource in the candidate resource set; determine a listen before talk class for a sidelink transmission; and transmit sidelink information on the transmission resource when listen before talk performed according to the listen before talk class is successful.

The embodiments of the present application further provide a network device, which may be, for example, a base station, but the embodiments of this disclosure are not limited thereto, and may also be other network devices.

FIG. 15 is a schematic diagram of composition of a network device in the embodiments of the present application. As shown in FIG. 15, a network device 1500 may include a processor 1510 (such as a central processing unit (CPU)) and a memory 1520; the memory 1520 is coupled to the processor 1510. The memory 1520 may store various data and also may store the information processing program 1530, and the program 1530 is executed under the control of the processor 1510. For example, the processor 1510 may be configured to execute a program to transmit a message/configuration/information/signaling/indication to a terminal equipment, such that the terminal equipment implements the sidelink transmission method described in the embodiments of the first aspect.

In addition, as shown in FIG. 15, the network device 1500 may further include: a transceiver 1540 and an antenna 1550, etc., wherein the functions of the above components are similar to the related art, and are not repeated here. It is worth noting that the network device 1500 is not necessarily required to include all of the components shown in FIG. 15; in addition, the network device 1500 may further include components not shown in FIG. 15, with reference to the related art.

The embodiments of the present application further provide a terminal equipment, but the embodiments of this disclosure are not limited thereto, and may also be other devices.

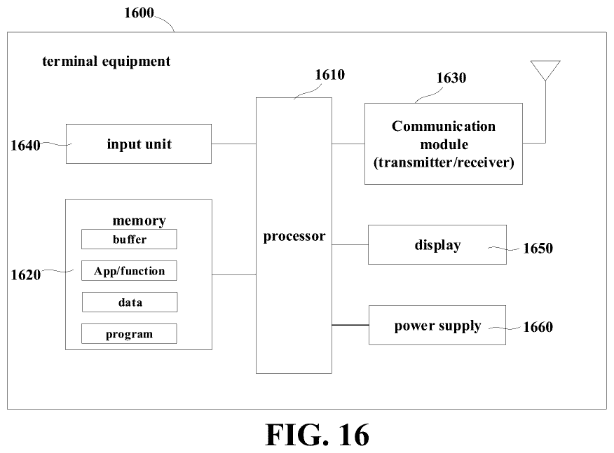

FIG. 16 is a schematic diagram of a terminal equipment in the embodiments of the present application. As shown in FIG. 16, a terminal equipment 1600 may include a processor 1610 and a memory 1620; the memory 1620 stores data and program, and is coupled to the processor 1610. It is worth noting that this figure is exemplary; other types of structures may also be used in addition to or instead of the structure to implement telecommunications functions or other functions.

For example, the processor 1610 may be configured to execute the program to implement the sidelink transmission method as described in the embodiments of the first aspect. For example, the processor 1610 may be configured to perform controlling as follows: determining a candidate resource set on an unlicensed frequency band; selecting a transmission resource in the candidate resource set; determining a listen before talk class for a sidelink transmission; and transmitting sidelink information on the transmission resource when listen before talk performed according to the listen before talk class is successful.

As shown in FIG. 16, the terminal equipment 1600 may further include a communication module 1630, an input unit 1640, a display 1650, and a power supply 1660. The functions of the above components are similar to the related art, and are not repeated here. It is worth noting that the terminal equipment 1600 is not necessarily required to include all of the components shown in FIG. 16, and the above components are not essential; in addition, the terminal equipment 1600 may further include components not shown in FIG. 16, with reference to the related art.

The embodiments of the present application further provide a computer program which, when being executed in the terminal equipment, causes the terminal equipment to execute the sidelink transmission method described in the embodiments of the first aspect.

The embodiments of the present application further provide a storage medium storing a computer program which causes the terminal equipment to execute the sidelink transmission method described in the embodiments of the first aspect.

The above devices and methods of the present application can be implemented by hardware or by hardware combined with software. The present application relates to a computer readable program which, when being executed by a logic unit, enables the logic unit to implement the devices or components mentioned above, or enables the logic unit to implement the methods or steps described above. The present application also relates to storage medium for storing the above programs, such as a hard disk, a magnetic disk, a compact disc, a DVD, a flash memory, etc.

The method/device described in conjunction with the embodiments of the present application may be directly embodied as hardware, a software module executed by the processor, or a combination of both. For example, one or more of the functional block diagrams and/or combination thereof shown in the drawing may correspond to both software modules and hardware modules of the computer program flow. These software modules can correspond to the steps shown in the drawings respectively. These hardware modules can be realized, for example, by solidifying these software modules using field programmable gate arrays (FPGA).

The software module may reside in an RAM memory, a flash memory, an ROM memory, an EPROM memory, an EEPROM memory, a register, a hard disk, a removable disk, a CD-ROM, or a storage medium in any other form known in the art. A storage medium can be coupled to a processor so that the processor can read information from the storage medium and write information to the storage medium; or the storage medium can be a constituent part of the processor. The processor and the storage medium can be located in the ASIC. The software module can be stored in the memory of the mobile terminal or in a memory card that can be inserted into the mobile terminal. For example, if a device (such as a mobile terminal) uses a large-capacity MEGA-SIM card or a large-capacity flash memory device, the software module can be stored in the MEGA-SIM card or the large-capacity flash memory device.

One or more of the functional blocks and/or combination thereof shown in the drawing may be implemented as a general-purpose processor, a digital signal processor (DSP), an application-specific integrated circuit (ASIC), a field programmable gate array (FPGA) or other programmable logic device, a discrete gate or a transistor logic device, a discrete hardware component, or any appropriate combination thereof, for performing the functions described in the present application.

One or more of the functional blocks and/or combination thereof shown in the drawing may also be implemented as combination of computing devices, such as combination of DSP and a microprocessor, multiple microprocessors, one or more microprocessors combined with DSP communication, or any other such configuration.

The present application is described in combination with specific embodiments hereinabove, but a person skilled in the art should know clearly that the description is exemplary, but not limitation to the protection scope of the present application. A person skilled in the art can make various variations and modifications to the present application according to spirit and principle of the application, and these variations and modifications should also be within the scope of the present application.

For implementation including the above embodiments, the following supplements are further disclosed:

1. A sidelink transmission method, including:
determining a candidate resource set by a first device on an unlicensed frequency band;
selecting a transmission resource in the candidate resource set;
determining a listen before talk (LBT) class for a sidelink transmission; and
transmitting sidelink information on the transmission resource when listen before talk (LBT) performed according to the LBT class is successful.

2. The method according to the supplement 1, wherein the first device determines the LBT class according to whether the sidelink transmission is within a channel occupancy time (COT).

3. The method according to the supplement 2, wherein the LBT class is determined to be low class or high class in the case where the sidelink transmission is within the channel occupancy time (COT).

4. The method according to the supplement 2 or 3, wherein the LBT class is determined to be high class in the case where the sidelink transmission is outside the channel occupancy time (COT).

5. The method according to any of the supplements 2 to 4, wherein the channel occupancy time (COT) is obtained via a COT indication received by the first device.

6. The method according to any of the supplements 2 to 4, wherein the channel occupancy time (COT) is obtained by the first device performing listen before talk (LBT).

7. The method according to the supplement 6, wherein the first device obtains the channel occupancy time (COT) by performing the listen before talk (LBT) according to a high-class LBT.

8. The method according to any of the supplements 2 to 7, wherein the method further includes:
the first device receiving one or more COT indications indicating first channel occupancy times (COT); and
determining a second channel occupancy time (COT) for obtaining the LBT class, according to one or more channel occupancy times (COT) and/or the channel occupancy time (COT) obtained by performing listen before talk (LBT).

9. The method according to the supplement 8, wherein the second channel occupancy time (COT) for obtaining the LBT class is indicated by a COT indication transmitted by a second device, the first device and the second device satisfying at least one of the following conditions:
the RSRP between the first device and the second device is greater than the first threshold;
a distance between the first device and the second device is less than a second threshold;
the first device is a transmitter of sidelink information of the second device;
the first device is a receiver of the sidelink information of the second device;
the first device and the second device have identical cast types; or
a channel access priority class (CAPC) value of the first device is less than a channel access priority class (CAPC) value of the second device.

10. The method according to the supplement 1, wherein the sidelink transmission is a first transmission within the channel occupancy time (COT), and the first device determines the LBT class for the first transmission according to a second transmission prior to the first transmission.

11. The method according to the supplement 10, wherein the LBT class is determined as a low class when a time interval between the first transmission and the second transmission is less than a threshold.

12. The method according to the supplement 10 or 11, wherein the LBT class is determined as a high class when a time interval between the first transmission and the second transmission is greater than or equal to the threshold.

13. The method according to any of the supplements 10 to 12, wherein the second transmission includes at least one of the following:
a sidelink transmission of the first device;
a sidelink transmission of the third device transmitting a COT indication for indicating the channel occupancy time (COT); or
a sidelink transmission of a fourth device not transmitting the COT indication for indicating the channel occupancy time (COT).

14. The method according to the supplement 13, wherein the first device and the third device satisfy at least one of the following conditions:
the RSRP between the first device and the third device is greater than the first threshold;
a distance between the first device and the third device is less than a second threshold;
the first device is a transmitter of sidelink information of the third device;
the first device is a receiver of the sidelink information of the third device;
the first device and the third device have identical cast types; or
a channel access priority class (CAPC) value of the first device is less than a channel access priority class (CAPC) value of the third device.

15. The method according to the supplement 13, wherein the first device and the fourth device satisfy at least one of the following conditions:
the RSRP between the first device and the fourth device is greater than the first threshold;
a distance between the first device and the fourth device is less than a second threshold;
the first device is a transmitter of sidelink information of the fourth device;
the first device is a receiver of the sidelink information of the fourth device;
the first device and the fourth device have identical cast types; or
a channel access priority class (CAPC) value of the first device is less than a channel access priority class (CAPC) value of the fourth device.

16. The method according to any of the supplements 10 to 15, wherein the second transmission and the first transmission are within identical channel occupancy times (COT).

17. The method according to any of the supplements 1 to 16, wherein a frequency at which the first device monitors the physical sidelink control channel (PSCCH) outside the channel occupancy time (COT) is higher than a frequency at which the first device monitors the physical sidelink control channel (PSCCH) inside the channel occupancy time (COT).

18. A sidelink transmission method, including:
a first device obtaining a channel occupancy time (COT) on an unlicensed frequency band; and
the first device monitoring a physical sidelink control channel (PSCCH),
wherein a frequency of monitoring a physical sidelink control channel (PSCCH) outside the channel occupancy time (COT) is higher than a frequency of monitoring a physical sidelink control channel (PSCCH) within the channel occupancy time (COT).

19. The method according to the supplement 18, wherein the channel occupancy time (COT) is obtained via a COT indication received by the first device.

20. The method according to the supplement 18, wherein the channel occupancy time (COT) is obtained by the first device performing listen before talk (LBT).

21. A terminal equipment including a memory storing a computer program and a processor configured to execute the computer program to implement the sidelink transmission method according to any of the supplements 1 to 20.

What is claimed is:

1. A sidelink transmission apparatus, comprising:
processor circuitry configured to determine a candidate resource set on an unlicensed frequency band; select a transmission resource in the candidate resource set; determine a listen before talk (LBT) class for a sidelink transmission; and determine a second channel occupancy time to share according to one or more first channel occupancy times;
a transmitter configured to transmit sidelink information on the transmission resource when listen before talk which is performed according to the listen before talk class is successful; and
a receiver configured to receive one or more COT indications indicating the one or more first channel occupancy times

2. The sidelink transmission apparatus according to claim 1, wherein the second channel occupancy time is indicated by a COT indication transmitted by a first communication apparatus, the sidelink transmission apparatus and the first communication apparatus satisfying at least one of the following conditions:
the transmitter transmits sidelink information to the first communication apparatus,
the receiver receives sidelink information from the first communication apparatus;
the sidelink transmission apparatus and the first communication apparatus have identical cast types; or
a channel access priority class value of the sidelink transmission apparatus is less than a channel access priority class value of the first communication apparatus.

3. The sidelink transmission apparatus according to claim 2 wherein the channel access priority class value is carried in a 2nd stage SCI.

4. The sidelink transmission apparatus according to claim 1, wherein the processor circuitry is configured to determine the listen before talk class according to whether the sidelink transmission is within a channel occupancy time (COT).

5. The sidelink transmission apparatus according to claim 4, wherein when the sidelink transmission is within the channel occupancy time, the listen before talk class is determined as a low class or a high class.

6. The sidelink transmission apparatus according to claim 4, wherein when the sidelink transmission is outside the channel occupancy time, the listen before talk class is determined as a high class.

7. The sidelink transmission apparatus according to claim 4, wherein the channel occupancy time is obtained via a COT indication received by the sidelink transmission apparatus.

8. The sidelink transmission apparatus according to claim 4, wherein the channel occupancy time is obtained by performing listen before talk by the sidelink transmission apparatus.

9. The sidelink transmission apparatus according to claim 8, wherein the processor circuitry is configured to obtain the channel occupancy time by performing the listen before talk according to a high-class listen before talk.

10. The sidelink transmission apparatus according to claim 1, wherein the sidelink transmission is a first transmission within the channel occupancy time, and a listen before talk class is determined for the first transmission according to a second transmission prior to the first transmission.

11. The sidelink transmission apparatus according to claim 10, wherein the listen before talk class is determined as a low class when a time interval between the first transmission and the second transmission is less than a threshold.

12. The sidelink transmission apparatus according to claim 10, wherein the listen before talk class is determined as a high class when a time interval between the first transmission and the second transmission is greater than or equal to a threshold.

13. The sidelink transmission apparatus according to claim 10, wherein the second transmission comprises at least one of the following:
a sidelink transmission of the sidelink transmission apparatus;
a sidelink transmission of a second communication apparatus transmitting a COT indication for indicating the channel occupancy time; or
a sidelink transmission of a third communication apparatus not transmitting a COT indication for indicating the channel occupancy time.

14. The sidelink transmission apparatus according to claim 13, wherein the sidelink transmission apparatus and the second communication apparatus satisfy at least one of the following conditions:
reference signal receiving power between the sidelink transmission apparatus and the second cumminication apparatus is greater than a first threshold;
a distance between the sidelink transmission apparatus and the second cumminication apparatus is less than a second threshold;
the sidelink transmission apparatus is a transmitter of sidelink information of the second communication apparatus;
the sidelink transmission apparatus is a receiver of the sidelink information of the second cumminication apparatus;
the sidelink transmission apparatus and the second communication apparatus have identical cast types; or
a channel access priority class value of the sidelink transmission apparatus is less than a channel access priority class value of the second communication apparatus.

15. The sidelink transmission apparatus according to claim 13, wherein the sidelink transmission apparatus and the third communication apparatus satisfy at least one of the following conditions:
reference signal receiving power between the sidelink transmission apparatus and the third communication apparatus is greater than a first threshold;
a distance between the sidelink transmission apparatus and the third communication apparatus is less than a second threshold;
the sidelink transmission apparatus is a transmitter of sidelink information of the third communication apparatus;
the sidelink transmission apparatus is a receiver of the sidelink information of the third communication apparatus;
the sidelink transmission apparatus and the third communication apparatus have identical cast types; or
a channel access priority class value of the sidelink transmission apparatus is less than a channel access priority class value of the third communication apparatus.

16. The sidelink transmission apparatus according to claim 10, wherein the second transmission and the first transmission are within the same channel occupancy time.

17. The sidelink transmission apparatus according to claim 1, wherein a frequency of monitoring a physical sidelink control channel outside the channel occupancy time is greater than a frequency of monitoring a physical sidelink control channel within the channel occupancy time.

18. A sidelink transmission method, comprising:
determining a candidate resource set on an unlicensed frequency band;
selecting a transmission resource in the candidate resource set;
determining a listen before talk (LBT) class for a sidelink transmission; and
transmitting sidelink information on the transmission resource when listen before talk which is performed according to the listen before talk class is successful;
wherein the method further comprises:
receiving one or more COT indications indicating one or more first channel occupancy times, and
determining a second channel occupancy time to share according to the one or more first channel occupancy times.

19. A communication system, comprising:
a first communication device; and
a second communication device configured to communicate with the first communication device,
wherein the first communication device is configured to: determine a candidate resource set on an unlicensed frequency band; select a transmission resource in the candidate resource set; determine a listen before talk (LBT) class for a sidelink transmission; and transmit sidelink information on the transmission resource when listen before talk which is performed according to the listen before talk class is successful;
the first communication device is further configured to: receive one or more COT indications indicating one or more first channel occupancy times, and determine a second channel occupancy time to share according to the one or more first channel occupancy times.
